(19) United States
(12) Patent Application Publication
(10) Pub. No.: US 2017/0252711 A1
(43) Pub. Date: Sep. 7, 2017

(54) AGITATOR FOR MIXING FLUIDS

(71) Applicant: WUSOA GMBH, Stuttgart (DE)

(72) Inventor: Martin FALGER, Sonntag (AT)

(73) Assignee: WUSOA GMBH, Stuttgart (DE)

(21) Appl. No.: 15/145,693

(22) Filed: May 3, 2016

Related U.S. Application Data
(63) Continuation of application No. PCT/EP2014/073689, filed on Nov. 4, 2014.

(30) Foreign Application Priority Data
Nov. 8, 2013 (DE) 10 2013 018 725.7

(51) Int. Cl. B01F 7/30; B01F 7/00

(52) U.S. Cl. CPC B01F 7/30; B01F 7/00316; B01F 2215/0422

(57) ABSTRACT

The invention relates to an agitator for mixing of fluids with different viscosities, wherein the agitator has a main shaft rotatable about an axis of rotation and paddles supported by the main shaft, each paddle comprising a paddle shaft extending at an angle relative to the axis of rotation of the main shaft ranging between 20° and 40°, and the paddles being arranged around the main shaft spaced by an angle of 90° relative to one another, and the paddles with the agitator being rotatable about the axis of rotation of the main shaft and also about the respective paddle shaft axis, wherein a radial first distance of the paddle shaft axes relative to the axis of rotation at a lower end of the paddle shafts facing away from the main shaft is larger than a radial second distance of the paddle shaft axes relative to the axis of rotation at an upper end of the paddle shafts facing the main shaft.

This is a continuation-in-part application of pending international application PCT/EP2014/073689 filed Nov. 4, 2014 and claiming the priority of German patent application 10 2013 018 725.7 filed Nov. 8, 2013.

### BACKGROUND OF THE INVENTION

The invention relates to an agitator for mixing fluids with different viscosities with an agitator shaft including agitator pedals extending from the agitator shaft.

Agitators for agitating or mixing, respectively, fluids are known. For agitating or mixing, respectively, the fluid propellers or modifications of a propeller, respectively, are employed, which are referred to as agitator. Propellers or the modifications respectively, thereof are to be understood as devices which consist of two or more blades or paddles, respectively, which are arranged equally spaced about the agitator shaft. The propeller mixes fluids, while the blades or paddles, respectively, rotating with the agitator shaft.

Agitators with propellers are utilized for mixing various fluids. For example, patent specification CH 690836 A5 discloses an agitator for agitating a dough, wherein additional elements are attached to the blades or paddles, respectively, in order to influence the generated flow behaviour.

Utility model AT 007987 U1 shows an agitator for biomass, sewage sludge or the like, whose propeller axis or whose drive shaft, respectively, assumes various angles relative to the horizontal in order to achieve a better spatial mixing of the fluid.

A movable propeller of an agitator, which may be moved in the longitudinal direction along its drive axis, may be taken from utility model DE 20 2008 015 990 U1. A propeller whose axis may be inclined is disclosed in patent specification DE 197.56 485 C2.

An agitator is known from the unexamined patent application DE 10 2010 002 461 A1, which is enclosed by a shroud with several openings, so that the fluid is sucked or pressed, respectively, through the channel, whereby a movement is generated.

Beside the employment of various configurations of the propeller, there are other forms which have been used to mix fluids, as may be taken form DE 91 02 832 U1, DE 20 2011 052 408 U1, DE 20 2011 107 055 U1, DE 6 910 714 T2 or DE 88 11 813 U1.

It is the object of the present invention to provide an agitator for improved mixing of the fluids with different viscosities.

### SUMMARY OF THE INVENTION

The inventive agitator for mixing fluids with different viscosities, wherein the agitator is a bionic agitator, comprises a main shaft and paddles. The paddles are connected with the main shaft, wherein the paddles each have a paddle shaft with a paddle shaft axis. The paddle shaft axes have a first angle relative to the axis of rotation, which ranges between 20° and 40°. The paddles are arranged circumferentially spaced about the main shaft at a second angle of 90° relative to one another. With the agitator operating, the paddles perform a first rotation about the main shaft and a second rotation about the respective paddle shaft axis. A radial first distance of the paddle shaft axes relative to the axis of rotation at a lower end of the paddle shafts, which is formed facing away from the main shaft, is larger than a radial second distance of the paddle shaft axes relative to the axis of rotation at an upper end of the paddle shafts, which is formed facing the main shaft. The arrangement provides for efficient and thorough mixing of the different fluids.

From the state of the art an oblique position of the paddles in the area of the paddles facing away from the main shaft towards the inside, i.e. a position of the paddles towards the axis of rotation is known. With the same shape of the paddles, the inventive position, and rotation of the paddles also about the paddle axes results in a considerably larger circumferential radius because of the outwardly directed paddles, whereby an enlarged flow radius may be achieved as well, which ultimately leads to an improved flow of the fluid and thus to improved mixing of the fluid.

In an embodiment, the first rotation may be transferred to the paddles via a non-rotating connection between the main shaft and the paddles, and the second rotation may be transferred to the paddles via a friction or gear drive, which is arranged between the main shaft and the paddle shafts.

Preferably, the paddle shafts are supported by means of second guide tubes rotatably receiving the paddle shafts, which tubes are supported for rotation with, and relative to, the main shaft.

For making the connection, it is particularly preferred to mount the second guide tubes non-rotatably at a housing which is supported so as to be rotatable relative to the main shaft. This provides the possibility to fix the guide tubes at the housing.

In a further embodiment of the inventive agitator, as the friction drive a gear drive is used. By means of the gears, greater torque forces may be transferred.

Preferably, the gears are in the form of bevel gears so that an oblique position of the paddle shaft axis relative to the axis of rotation may be achieved in a simple manner.

In a further embodiment, the friction drive is accommodated in a transmission gear housing so that any entering of the fluid is prevented by means of seals at the transmission gear housing.

The paddle shafts preferably comprise stabilising tubes with support plates, wherein the stabilizing tubes are provided with notches for additional spring keys of the paddle shafts. This allows a rapid and precision-fit assembly and the paddles cannot be displaced from their specified angles or their specified positions, respectively, during operation. This fastening may also be accomplished by locks, bolts and other mechanical screw connections.

In a further embodiment of the inventive agitator, the paddle shafts comprise spring keys at one end facing away from the paddle for the connection to the stabilising tubes, with supports of the paddles being provided. This ensures that the stabilising tubes of the paddles may be rapidly assembled and that, upon movement of the paddles, the connections between den paddle shafts and the stabilising tubes of the paddles do not slip. Alternatively, all possible locks, bolts and other mechanical screw connections may also be used.

In a further embodiment of the inventive agitator, the paddle shafts are rotatably accommodated in second guide tubes, wherein they are connected via reinforcing means with a transmission gear housing of a smaller gear ratio, and wherein they are supported in multiple bearings and sealed against the transmission gear housing.

This is advantageous in that, by means of the second guide tubes, an improved stability and a smooth agitating behavior is achieved and, at the same time, the fluid is prevented from penetrating into the lower transmission gear housing.

Further advantages, features and details of the invention will become more readily apparent from the following description of the preferred exemplary embodiments with reference to the accompanying drawings. The features and feature combinations mentioned above as well as the features and feature combinations mentioned in the following description of the figures and/or shown only in the figures are not only applicable in the respective indicated combination, but also in other combinations or alone, without exceeding the scope of the invention. Similar or functionally identical elements are assigned identical reference numerals. For the sake of clarity, the elements might not be provided with their reference numerals in all figures, without, however losing their assignment.

### BRIEF DESCRIPTION OF THE DRAWINGS

FIG. 1 is a perspective view of an inventive agitator with a drive,

FIG. 2 shows a section through a lower transmission gear of the agitator,

FIG. 3 is a perspective view of the lower transmission gear according to FIG. 2,

FIG. 4 is a perspective view of the paddle of the agitator according to FIG. 1,

FIG. 5 is a partial section of the lower transmission gear with paddle, and

FIG. 6 is a top view of the lower transmission gear with paddle.

### DESCRIPTION OF EXEMPLARY EMBODIMENTS

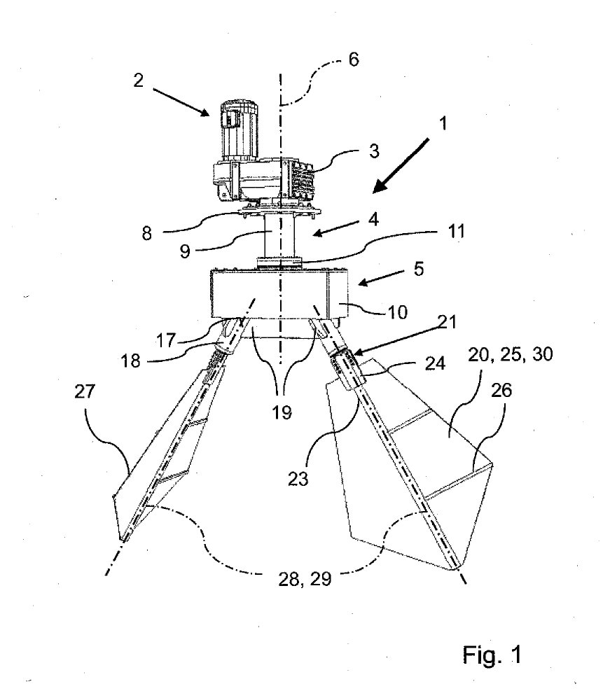

An inventive agitator 1 for mixing fluids, in particular a bionic agitator, is configured according to FIG. 1. The agitator 1 comprises a drive 2 which may set it in motion. The drive 2 may be designed electrically, pneumatically or hydraulically. In the illustrated exemplary embodiment the drive 2 is an electric motor.

Alternatively, water or a vapor, gasoline or another type of combustion engine may be employed. The drive 2 of the agitator 1 is determined by the viscosity and the quantity of the fluid to be moved or to be mixed, respectively, as well as by the objective.

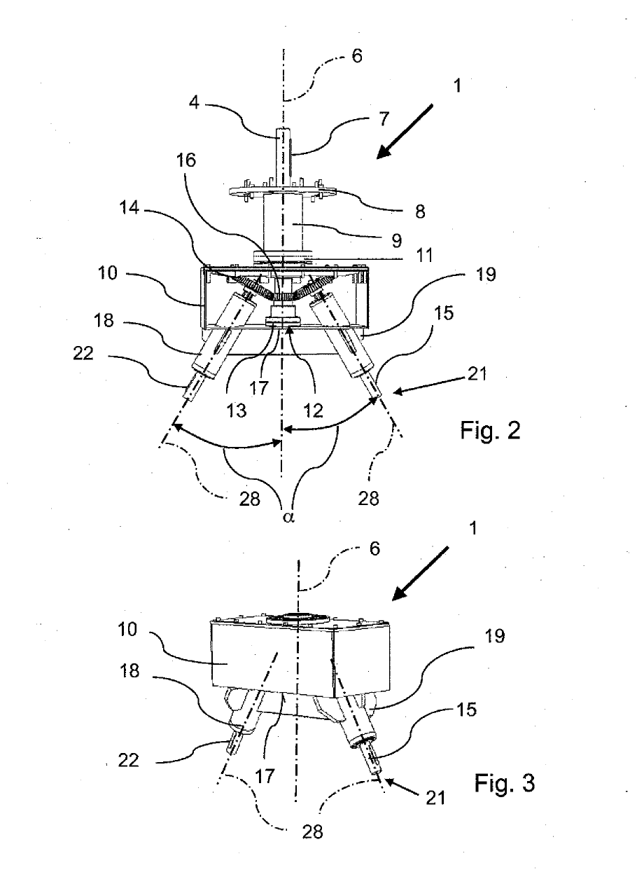

The drive 2 is coupled with a transmission gear 3 which in turn drives a main shaft 4 of the agitator 1, which is connected to a lower transmission gear 5 of the agitator 1, see in particular FIG. 2. The used gear ratio is dependent on the respective fluid and the objective. Depending on the requirement, the gear ratio covers a range from low to high speeds. The gear ratio is also adapted to the respective drive 2 in order to achieve an energy efficient and gentle mixing of the respective fluid.

The main shaft 4 is supported by several bearings. These multiple supports enable a relatively frictionless rotation about the axis of rotation 6. In addition, the multiple supports provide for an improved weight distribution to the individual bearings because the main shaft 4 carries the entire weight of the agitator 1.

An exact fit of the connection of the transmission gear 3 to the main shaft 4 is made my means of a spring key 7.

For the mounting of the agitator 1, a support plate 8 is provided. The support plate 8 may be efficiently connected with the device which is provided for mounting and which may consist of wood, concrete, stone, plastic or metal by means of screws, seals and bearings.

In this exemplary embodiment, the support plate 8 is for example arranged on a lid (not shown in detail) of a closed space (not shown in detail) in which the fluid to be agitated is located. Firstly, this connection of the agitator 1 to the lid achieves stability of the agitator 1 and, secondly, it prevents the fluid from escaping or that undesired fluid may penetrate into the space where the fluid is agitated, respectively. Depending on the condition of the lid and the fluid, different seals and different fastening means are employed. This design permits a rapid replacement of the respective components and a fast (re)start of the bionic agitator 1 after installation, maintenance or repair.

The support plate 8 is firmly connected to a guide tube 9 in which the main shaft 4 extends to the lower transmission gear 5 which is accommodated in a lower transmission gear housing 10. The guide tube 9 may also assume other shapes than a tube and the material may again vary. It is important however that it is sufficiently leakproof so that the fluid cannot enter the interior.

The lower end of the guide tube 9 which is positioned facing the lower transmission gear 5 is coupled via a connection 11 to the lower transmission gear 5 which is rotatable. In this case, too, the connection has to be sufficiently leakproof so that no fluid reaches the interior, and the lower transmission gear housing 10 has to be rotatable. These two requirements are met by different seals and supports.

The end 12 facing away from the drive 2 of the main shaft 4 which is connected to the transmission gear housing 10 via a supported mounting 13 is located in the transmission gear housing 10. Due to the rotation of the main shaft 4 the transmission gear housing 10 is also rotated so that the entire lower portion of the bionic agitator 1 rotates about the axis of rotation 6 of the main shaft 4. In other words, this means that the main shaft 4 is non-rotatably connected with the transmission gear housing 10.

In the transmission gear housing 10 bevel gears 14 are arranged, which define the ends of the paddle shafts 15 facing the drive 2. As can be seen in FIG. 2, one paddle shaft 15 each comprises one bevel gear 14. The bevel gears 14 are in operative connection, as can be seen in particular in FIG. 2, via a drive gear 16 which is non-connected for rotation with the main shaft 4. Thereby, a gear drive is formed.

The bevel gears 14 are driven by the cone-shaped gear drive 16 of the main shaft 4. Because of the connection of the bevel gears 14 to the respectively associated paddle shafts 15, the paddle shafts 15 are rotated.

The drive of the paddle shafts 15 in the transmission gear housing 10 formed by the bevel gears 14 and the drive gear 16 may also be performed by means of a toothed belt drive, swivel joint drive, belt drive, chain drive, magnets and others.

It is important that the transmission gear housing 10 is sufficiently sealed so that no fluid enters the interior and that the generated fluid flow is not affected by the size and shape of the transmission gear housing 10.

At a bottom side 17 of the transmission gear housing 10, which is facing away from the drive 2, second guide tubes 18 of the paddle shafts 15 are formed, with one second guide tube 18 each encompassing one paddle shaft 15 at least partially.

The second guide tubes 18 are attached at the transmission gear housing 10 by reinforcing means 19 which are formed at the bottom side 17. These reinforcing means 19 provide for a higher stability and a smooth and uniform movement of the paddles 20 mounted on the paddle shafts 15. As can be seen in particular in FIG. 1, one paddle shaft 15 each comprises one paddle 20.

The paddle shafts 15 are accommodated in their respectively assigned second guide tubes 18 and supported by multiple bearings. At the same time, they are also sealed by multiple seals so that no fluid can enter the interior of the transmission gear housing 10. In this context it should be noted that the mentioned seals may be formed as suitable rubber or metal seals. Here, in particular the fluid to be mixed is to be taken into consideration and if the fluid exhibits a corrosive and/or corroding property with respect to the material of which the used seals exists.

At a lower end 21 of the paddle shafts 15 facing away from the main shaft 4 or from the transmission gear housing 10, respectively, additional spring keys 22 for the connection to stabilising tubes 23 and mountings in the form of support plates 24 of the paddles 20 are provided. The additional spring keys 22 ensure that the stabilising tubes 23 of the paddles 20 may be rapidly assembled and that the connection between the paddle shaft 15 and the respective stabilising tube 23 is not displaced or loosened, respectively, by the movement of the paddles 20.

As can be seen in particular in FIG. 2, a radial first distance of the paddle shaft axes 28 relative to the axis of rotation 6 at the lower end 21 is larger than a second distance of the paddle shaft axes 28 relative to the axis of rotation 6 at an upper end of the paddle shafts 15 facing the main shaft 4, in particular at the bevel gears 14.

The stabilising tubes 23 with the support plates 24 which are provided with notches (not shown in detail) for the additional spring keys 22 are attached to the paddle shafts 15. This fastening may also be accomplished by locks, bolts and other mechanical screw connections.

The stabilising tubes 23 of the paddles 20 serve as mountings for the paddles 20, they increase the stability of the respective paddle 20 and also prevent twisting of paddle outer surface areas 25 of the paddles 20. In other words, this means that the stabilising tubes 23 stabilise the paddles 20 in their relative position and relatively to the main shaft 4, so that they maintain the desired position and angles or angular positions, respectively, as will be explained below.

The paddles 20 are provided with metal brackets 26 for reinforcement and flow improvement of the paddles 20. Moreover, the paddle edges 27 of the paddles 20 bent over, in order to further improve the flow behavior of the paddles 20.

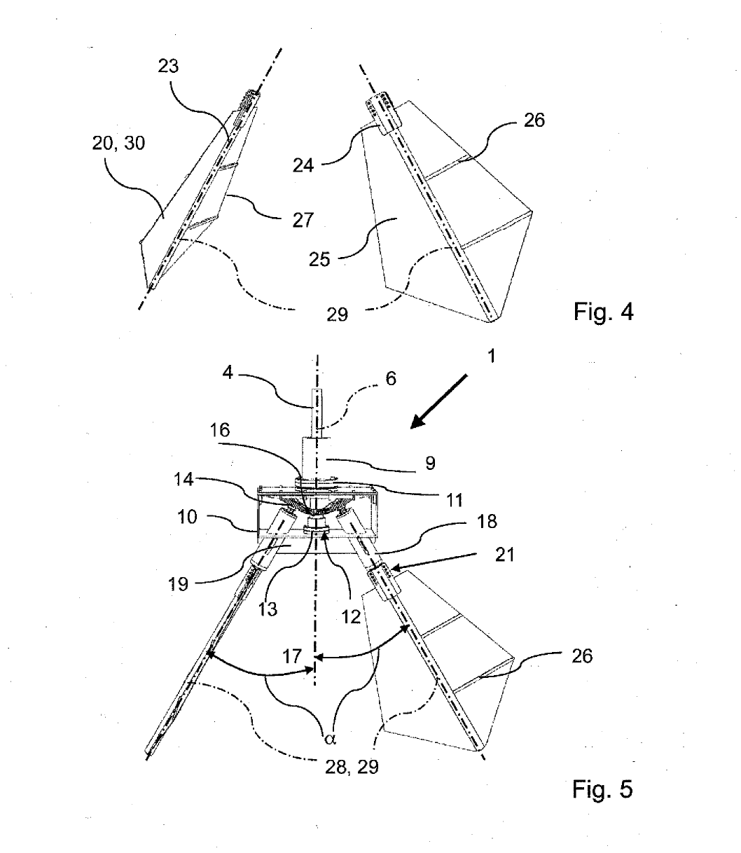

The shape, in other words the outer contours, and the size of the paddles 20 are determined by the fluid as well as the amount of fluid to be agitated. The following shapes for the paddles 20 are used: round, oval, triangular, trapezoidal, diamond-shaped, rhombic, parallelogram-shaped, square, rectangular, quadrangular and natural shapes from fauna and nature. The paddle 20 may also be bent or deformed if this helps to improve the stability of the paddles 20 and/or has a positive influence on the flow behaviour of the fluid. As shown in FIGS. 1, 2, 4 and 6, the paddle 20 is designed plane or plate-shaped, respectively.

The paddle shafts 15 with their shaft axes 28 and in an axial extension the paddles 20 with their coaxial paddle axes 29 are positioned at a first angle α of 20° to 40° relative to the main shaft 4 in order to generate an ideal flow behavior of the fluid.

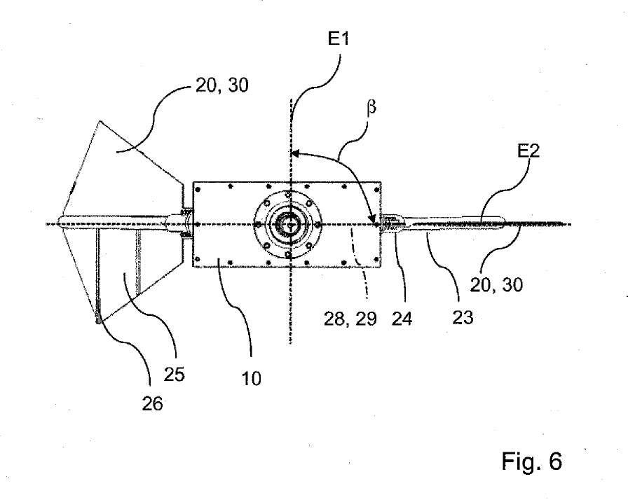

The paddles 20 are to be mounted at the paddle shafts 15 in such a manner that the paddle surfaces 30 are positioned at a second angle β of 90° to one another, as can be seen in particular in FIG. 6, in order to generate an ideal flow behaviour of the fluid. For a better understanding, a first sectional plane E1 of the one paddle surface 30 and a second sectional plane E2 of the other paddle surface 30 are drawn in. This shows that the paddle surfaces 30 are arranged at the second angle β of 90° to one another.

Due to the rotations of the paddles 20, i. e. by a first rotation of the paddles 20 about the axis of rotation 6 and by a second rotation of the respective paddles 20 about their associate paddle shaft axis 28, the fluid is pushed ahead of the paddles 20 or displaced, respectively. The thereby generated movement is responsible for a 360° shift of the fluid, which again leads to an intimate mixing of the constituents of the fluid and a maximum homogeneity of the fluid.

With this movement of the fluid, turbulences are reduced as far as possible and shear forces are avoided. This ensures a considerably better mixing of the fluid. At the same time, the movement of the paddles 20 and the movement generated in the fluid have the consequence that far less energy is required for keeping the fluid in motion than with conventional agitators. Another advantage of this kind of agitating is that any solid substances in the fluid do not wrap around the paddles 20 or connections, i. e. the paddle shafts 15, the support plates 24 and the stabilising tubes 23.

FIGS. 3 and 5 are intended for better clarity.

The agitator 1 is manufactured and offered in a wide variety of sizes and configurations for the most diverse applications, wherein fluids are circulated or mixed, respectively. These may cover, for example, applications in agriculture (such as biogas plants with and without gas hoods, manure tanks, milk cooling etc.), in the industry (such as emulsion tanks, agitating techniques in laboratories etc.), in the food industry (such as soft drink and fruit juice producers, dairies, breweries etc.), in municipalities and communities (sewage treatment plants, drinking water treatment, stagnant bodies of water etc.) and many more.

The agitator may be made from any wood, plastic, carbon, metal-type and from other existing materials. The connections, in particular the paddle shafts 15, the support plates 24 and the stabilising tubes 23 which connect the components of the bionic agitator are always dependent on type and condition of the material from which the agitator is built. Accordingly, the connections may be screw connections, bonded connections, plug connections or riveted connections.

The inventive agitator 1 relates to agitating in various fields of application, such as e. g. agitating in biogas plants with and without gas hoods, agitating of manure in agricultural businesses, agitating in sewage treatment and wastewater systems of municipalities, communities and cities, agitating in water treatment plants, agitating in laboratories, agitating in the food industry, agitating in the metal industry, agitating in the chemical industry, circulating of air in residential buildings and residential complexes, circulating of air in air-conditioned and heated rooms, circulating of air in garden centres, circulating of air in commercial and industrial areas, to any orientation of the agitator in horizontal and vertical position, to any type of installation, to any embodiment of the agitator with respect to size and used materials, to any described agitator, the kind of the used drive, the gear ratios, the seals and the connections of which differs from the described, but which otherwise has the same objective as the described agitator 1.

What is claimed is:

1. An agitator for mixing fluids with different viscosities, wherein the agitator (1) has a main shaft (4) with an axis of rotation (6) and paddles (20) which are connected to the main shaft (4), with the paddles (20) each comprising a paddle shaft (15) with a paddle shaft axis (28), and the paddle shaft axes (28) extending at a first angle (α) relative to the axis of rotation (6) in the range of between 20° and 40°, and the paddles (20) with their paddle surface areas (30) being arranged spaced around the main shaft (4) relative to one another by a second angle (β) of 90°, and the paddles (20) with the agitator (1) being rotatable about the main shaft (4) and also being rotatable about the respective paddle shaft axes (28), the paddle shafts (15) having a radial first distance from the main shaft (4) at a lower end (21) of the paddle shafts (15) away from the main shaft (4) which is larger than a radial second distance of the paddle shafts (15) from the main shaft (4) at an upper end of the paddle shafts (15) facing the main shaft (4).

2. The agitator according to claim 1, wherein the paddle shaft support members (18) are guide tubes mounted for rotation with the main shaft (4), and the paddle shafts (15) are rotatably supported by the paddle shaft support members (18), rotation of the paddle shafts (15) being transmitted to the paddles (20) by a shaft drive (14, 16) arranged between the main shaft (4) and the paddle shafts (15).

3. The agitator according to claim 2, wherein the guide tubes (18) are firmly connected to a gear housing (10) which is supported so as to be rotatable with respect to the main shaft (4).

4. The agitator according to claim 2, wherein the guide tubes (18) are firmly supported by the gear housing (10) which is non-rotatably connected with the main shaft (4).

5. The agitator according to one claim 2, wherein the paddle drive comprises gears (14, 16).

6. The agitator according to claim 5, wherein the gears (14, 16) are bevel gears.

7. The agitator according to claims 5, wherein the shaft drive (14, 16) is accommodated in a drive housing (10).

8. The agitator according to claim 1, wherein the paddle shafts (15) comprise stabilising tubes (23) with mountings (24), and the stabilising tubes (23) are provided with notches for spring keys (22) of the paddle shafts (15).

9. The agitator according to claim 8, wherein the paddle shafts (15) comprise spring keys at an end facing away from the paddle (20) for the connection to stabilizing tubes (23) and wherein mounting structures (24) for the paddles are provided.

10. The agitator according to claim 4, wherein the paddle shafts (15) are rotatably accommodated in the guide tubes (18), which are connected to the gear housing (10) of a lower transmission gear (5) via reinforcing structures (19), and wherein the paddle shafts are supported in the guide tubes (18) by multiple bearings and sealed by several seals against the transmission gear housing (10).
